(19) United States
(12) Patent Application Publication
(10) Pub. No.: US 2013/0020815 A1
(43) Pub. Date: Jan. 24, 2013

(54) SLIDING DOOR PANEL HOLD OPEN ASSEMBLY

(71) Applicant: Gary R. Smith, Hatfield, PA (US)

(72) Inventor: Gary R. Smith, Hatfield, PA (US)

(73) Assignee: Overhead Door Corporation, Lewisville, TX (US)

(21) Appl. No.: 13/189,117

(22) Filed: Jul. 22, 2011

(51) Int. Cl. E05C 17/48; E05C 19/16

(52) U.S. Cl. 292/251.5; 292/263

(57) ABSTRACT

A sliding door panel and assembly is described, such that when in the door panel is in an open arrangement there is a functional cooperation or coupling between at least a first unit and a second unit of the assembly. The second unit is generally affixed to the sliding door and the first unit is fixedly mounted with a sliding door guide system or to a header/footer or frame. A third unit may be included with the assembly such that when the sliding door panel is positioned in the open arrangement, the third unit limits engagement between the first and second units. In addition, the third unit is positioned to limit linear movement of a slideable portion of the first unit thereby preventing damage.

### BACKGROUND

1. Technical Field

The present invention relates to door systems, and more particularly, to hold open devices for retaining a door system in an open position.

2. Introduction

Conventional sliding door systems typically include one or more sliding doors mounted in a track directing movement of the sliding doors between an open and closed position. During operation, sliding doors are commonly retained in the open position by hold open assemblies, which are typically rigidly attached to the sliding door and door frame. However, in the event a door is abruptly opened, movement of the sliding door can potentially damage the hold open assembly. For example, in the event the door is abruptly moved to the open position, excessive force on the door can cause components in the hold open assembly to bend and/or break thereby potentially rendering the hold open assembly inoperable. It is therefore the principal purpose of this invention to avoid these and other disadvantages of existing door systems.

### SUMMARY

In the embodiments described herein, a hold open assembly is operable to hold a sliding door panel in an open arrangement by way of a functional cooperation or magnetic coupling between a pair of floating plates. A first floating plate/element is generally affixed to the sliding door and a second floating plate slideably secured to a base assembly disposed on a stationary structure, such as a door guide, header/footer or a door frame. In operation, when the sliding door is transitioned to a fully open position, magnetic contact between the floating plates enables the door to be held open until a user provides sufficient force to overcome the magnetic attraction, at which time the door will be released from the open position. Preferably, a door stop is utilized to limit the distance of travel of the sliding door panel to prevent and/or otherwise limit the likelihood of damage to the hold open assembly (i.e., breaking, cracking, bending, or dislodging of floating plates and/or the structure supporting the floating plates). In particular, hold open assembly is mounted at position allowing contact between the floating plates just prior to a leading edge of the door panel contacting the stop. If excessive force is used to move the door and the door continues to move after contact between the plates of the hold open assembly, the base assembly enables continued movement of the floating plates (and thus the door) until the door contacts and is stopped by the door stop. Thus, the sliding movement of the hold open assembly coupled with the use of a door stop prevents unintended damage to the hold open assembly during situations of excessive force or door movement.

Those skilled in the art will further appreciate the above-mentioned advantages and superior features of the invention together with other important aspects thereof upon reading the detailed description which follows in conjunction with the drawings.

### BRIEF DESCRIPTION OF THE DRAWINGS

For more complete understanding of the features and advantages of the inventions described herein, reference is now made to a description of the invention along with accompanying figures, wherein:

FIG. 1 is a front view of a representative door panel and hold open assembly with the door panels in a closed position;

FIG. 2 is a top view of the door panel and hold open assembly of FIG. 1;

FIG. 3 is a front view of the door panel and hold open assembly of FIG. 1 in the open position;

FIG. 4 is a top view of the door panel and hold open assembly illustrated in FIG. 3;

FIGS. 5A and 5B are representative schematics of a portion of the hold open assembly illustrated in FIGS. 1-4;

FIG. 6 is a representative top view of separate portion of the hold open assembly illustrated in FIGS. 1-4;

FIG. 7 is a representative side view of the portion of the hold open assembly illustrated in FIG. 6;

FIG. 8 is a representative front view of the floating plates illustrated in FIG. 6 or 7.

FIG. 9 is a top view of another representative door panel and hold open assembly, with door panels in the closed position; and

FIG. 10 is a top view of the representative door panel and hold open assembly of FIG. 9 with a door panel in the open position.

### DETAILED DESCRIPTION

Although making and using various embodiments are discussed in detail below, it should be appreciated that as described herein are provided many inventive concepts that may be embodied in a wide variety of contexts. Embodiments discussed herein are merely representative and do not limit the scope of the invention.

The drawing figures are not necessarily to scale and certain features may not be shown or may be exaggerated in scale or in somewhat generalized or schematic form in the interest of clarity and conciseness. In the following description, like numbers refer to like elements.

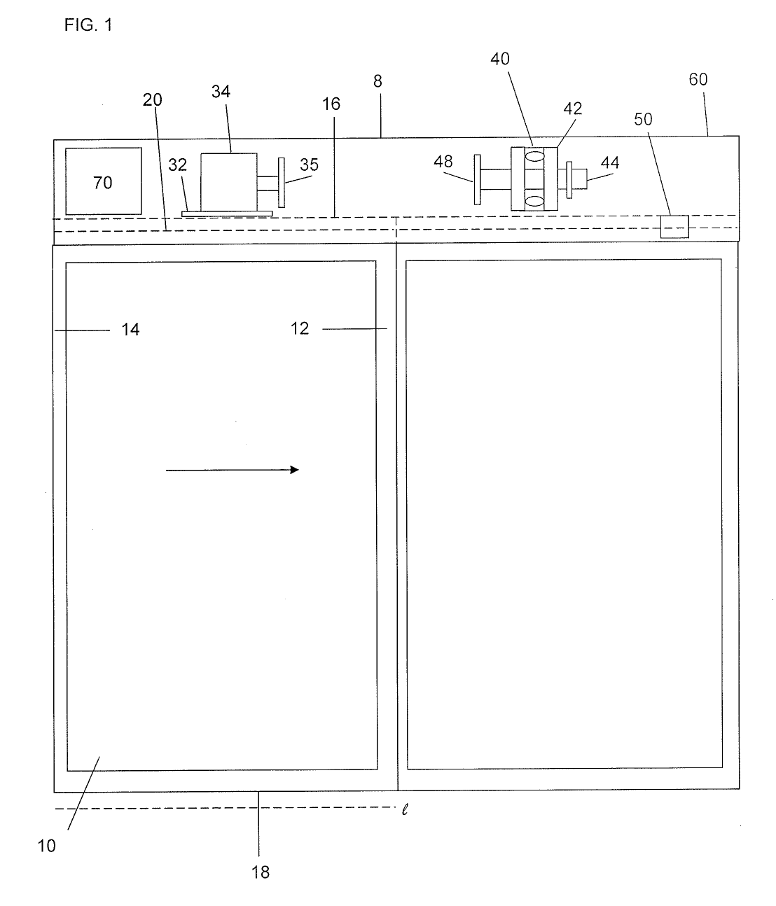

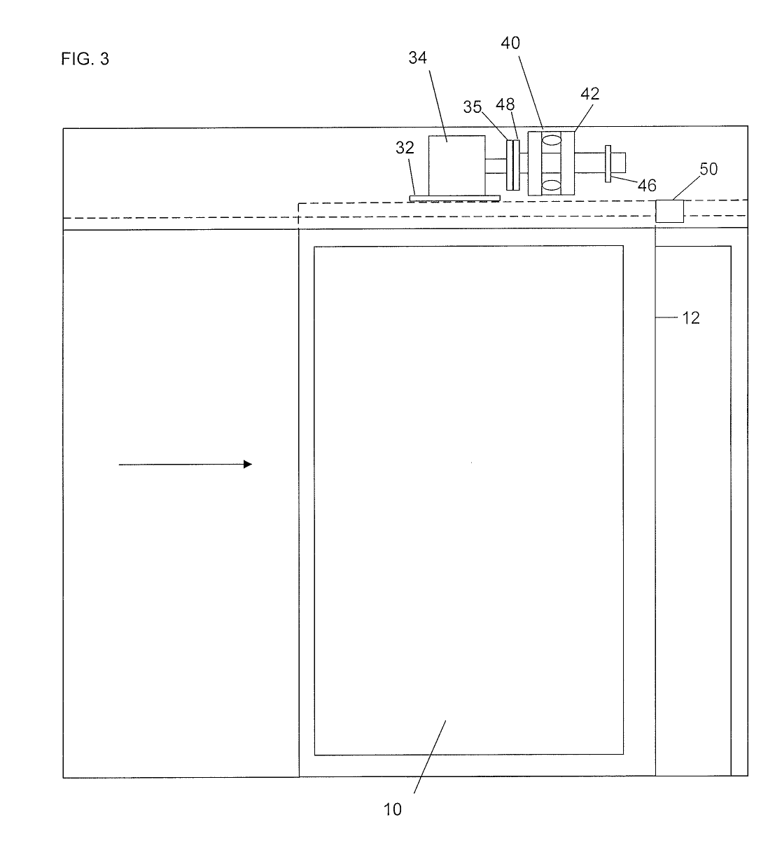

Described herein is a door hold open assembly 8 for retaining a sliding door panel 10 in an open position. In the embodiment illustrated in FIG. 1 and as discussed in further detail below, hold open assembly 8 comprises a floating element/plate 35 secured to sliding door panel 10 and cooperable with a corresponding magnetic floating element/plate 48 that is disposed on a stationary base assembly 40, both operable to retain door panel 10 in the open position (FIGS. 3 and 4). According to embodiments disclosed herein, base member 40 comprises a laterally movable piston 44 that supports floating plate 48 to allow for, as discussed in greater detail below, a flexible and non-rigid engagement between floating plate 35 and floating plate 48 as floating plate 35 approaches plate 48 when door 10 is moved to the open position. Embodiments disclosed herein are designed to minimize and/or otherwise eliminate potential damage to hold open assembly 8 as door panel 10 is moved to the open position.

In the embodiment illustrated in FIGS. 1-4, door panel 10 is movable within a guide system 20 and is operable between a closed position (FIG. 1) and an open position (FIG. 3). Door panel 10 may be described as having a leading edge 12 for contacting a stop member 50 in order to limit door travel, a trailing edge 14, a top 16 and a bottom 18. In various embodiments, the door may further comprise horizontal and vertical stiles, which may form a frame, or a door panel described herein may have a separate frame.

In FIGS. 1-4, door panel 10 is illustrated to be movable along a linear trajectory and is generally guided by panel guide system 20; however, it should be understood that non-linear movement of door panel 10, such as in an arc or other path, may be utilized. Furthermore, movement of door panel 10 may be in the horizontal direction (as illustrated), the vertical/upward direction or in an angled direction and may be operated manually or with a mechanically or motor driven operator 70 (FIG. 1). In addition, while panel guide system 20 is depicted in FIG. 1 as positioned on the upper end of door panel 10, guide system 20 may also be positioned above door panel 10, on the lower end of door panel 10, below door panel 10 or any suitable combination thereof.

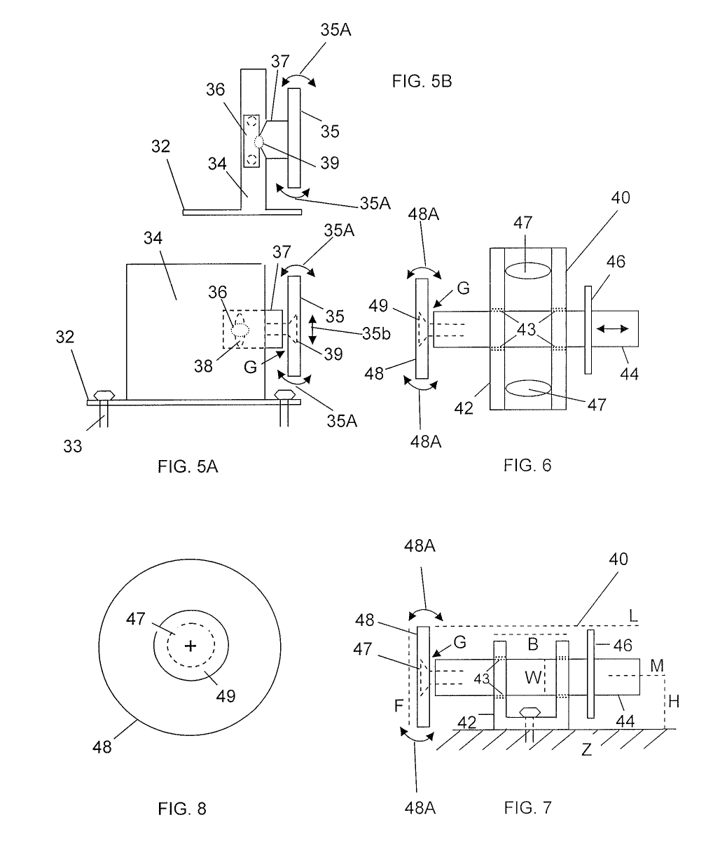

Referring to FIGS. 1-5A, floating plate 35 is mounted to door panel 10 via a base member 32, which is secured to door panel 10 via one or more fasteners 33 (FIG. 5A). A support body/plate 34 is mounted to and extends from base 32, which may be fixedly secured to base 32 or integral therewith. Furthermore, body 34 may be configured to support additional features that are not illustrated, such as, for example, connecting elements and/or an end of a door cable that is operable with a mechanical or motor-driven operator 70 to move door panel 10 between the open and closed positions.

Connected to body 34 is a subassembly that allows movement of plate 35 relative to support body/plate 34, the movement being depicted by arrows 35A (FIG. 5A). In one form, the subassembly comprises floating plate 35 pivotably disposed on a mounting element 37. In particular, floating plate 35 fixedly but not rigidly secured to element 37 by way of a fastener 39, which is tightened a sufficient amount to provide a gap G between floating plate 35 and the end of mounting element 37. This enables a pivoting motion of floating plate 35 with respect to mounting element 37 and thus, plate 34, to enable plate 35 to rest flush against plate 48 in the event door 10 is tilted or otherwise angled that would otherwise prevent flush alignment of plates 35 and 48. Referring specifically to FIG. 5A, in some embodiments, the position of mounting element 37 may be adjusted within a slot 38 to allow movement in the direction indicated by arrows 35B. This facilitates alignment of floating plate 35 with corresponding floating plate 48 of base assembly 40 such that they are aligned in a common trajectory. Alternatively and referring specifically to FIG. 5B, floating plate 35 may be connected to body 34 by a semi-spherical slip/ball joint 39 disposed on or otherwise within support body 34. While not illustrated herein, mounting element 37 may be retractable, having, for example, a telescoping means, generally in a more extended position when the door panel is in the closed position, and/or mounting element 37 may be combined and cooperative with a means for absorbing mechanical force, such as a shock absorber.

Referring now to FIGS. 6 and 7, base assembly 40 is shown to generally comprise a mounting unit or bracket 42, a piston 44, a retainer ring 46 and floating element/plate 48. Piston 44 is sized and shaped for positioning within an opening 43 of bracket 42. The piston is elongated so that its length (see dashed line, L, FIG. 7) is significantly greater than its width (W) or cross-sectional diameter. The width of piston 44 is generally constant along its entire length. In cross section, the piston may be of any shape, such as circular, oval, rectangular, square, polygonal, and variations, thereof. Openings 43 are generally sized and shaped to cooperate with piston 44 and its shape, allowing movement of piston 44 within opening 43, said movement being of relative ease and with little resistance and taking place along the length of piston 44, generally in the direction of arrow 45. The movement may be further augmented with use of a lubricant or material that assists in ease of movement. Retainer ring 46, located near a first end of piston 44, prevents piston 44 from separating from bracket 42. Floating plate 48 is located at a second and opposing end of the piston and is fixedly but not rigidly secured to piston 44 by way of a fastener 49. For example, fastener 49 is tightened a sufficient amount to provide a gap G between floating plate 48 and the second end of piston 44 to enable a pivoting motion in the direction of arrows 48A of the floating plate with respect to piston 44. Other means for securing floating plate 48 to piston 44 are also suitable. For example, a means, such as depicted in FIG. 5B that includes a slip joint may be used in connection with floating plate 48 in order to allow movement of floating plate 48 relative to piston 44.

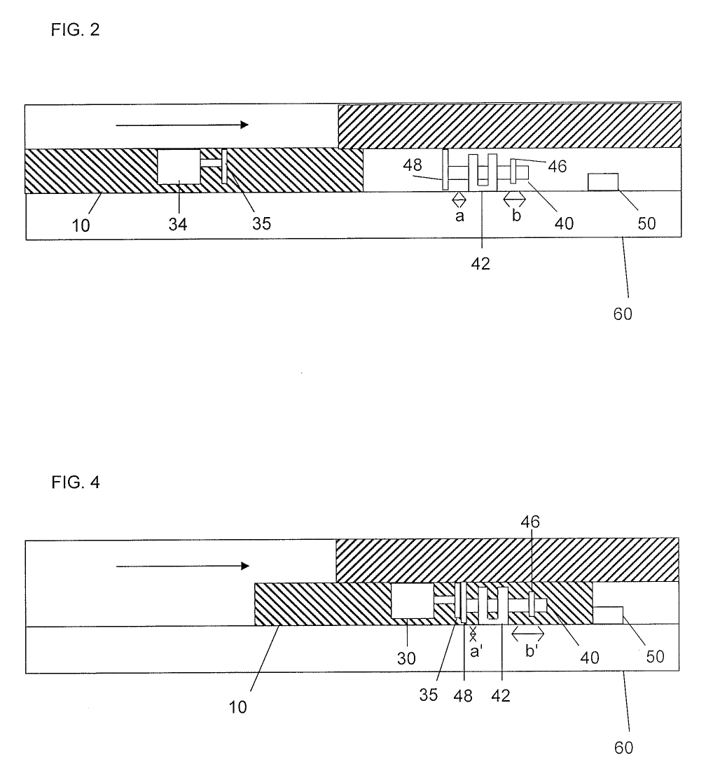

Base assembly 40 is generally fixedly mounted by any means for mounting, such as screwing, bolting, joining, adhering, pressing, soldering, and welding, as examples, by way of bracket 42. In one of more embodiments, bracket 42 includes one or more slots 47 for placement of fasteners. Base unit 40 may be mounted to a structure, Z (FIG. 7), such as a wall, track, header/footer or frame, when included, or other suitable feature incorporated with the sliding door assembly, such that, when mounted, a side view of the hold open unit is visible from a top viewing, such as illustrated in FIGS. 2 and 4. As depicted in FIGS. 1-4, the hold open assembly 8 and stop 50 are located at the upper end of sliding door panel 10. This assembly, however, may fully function at alternative locations, such as a lower end of the sliding door panel 10 or on the side, if sliding occurs in a vertical or angled direction. By positioning floating plate 35 on door panel 10 in a common trajectory with the base assembly 40, and more particularly, floating plate 48, when door panel 10 is in the fully open position, floating plates 35 and 48 are magnetically attracted to each other. The selected materials should be such that the two plates are releasable when a user pulls the door panel in the opposing direction allowing the door panel to close freely.

Furthermore, base assembly 40 may be of any suitable dimension such that the features described above are met. In one or more embodiments, as illustrated with FIG. 7, the piston length (L) may be about 2 inches, the bracket (B) may be about 1 inch wide and the distance (H) from the mounted structure (Z) to the midline of the piston (M) is about 0.63 inches. The floating plates may have a width or cross sectional diameter of about 1.4 inches or 1.75 inches or variations thereof, when circular. Other shapes (square, polygonal, etc.) may also be applied with the floating plates described herein. Generally, floating plate 40 is made of a magnetic material that has a pull, such as up to about 10 pounds, or about 13 pounds, or about 20 pounds or about 25 pounds, as examples. In one or more forms, a floating end is a disc magnet. In additional forms, a floating plate 48 is a ceramic pot or round magnet with a center hole (e.g., McMaster-Carr No. 5685 K26). Optionally, floating plate 48 is made of a material or composite material that exhibits a magnetic interaction in the presence of a field. For example, floating plate 48 may be an electromagnet (e.g., with a wire coiled around a metal core). A current drawn through the wire will develop a sufficient magnetic field to hold the door open and may be released to allow the door to close freely.

Referring back to FIGS. 1-3, door stop 50 is utilized to limit door travel thereby preventing potential damage to door 10 and/or hold open assembly 8 (i.e., breaking, cracking, bending, or dislodging of floating plates 35 and/or 48 or bracket 42). In particular, stop 50 is positioned so that when door 50 is fully opened as illustrated in FIGS. 3 and 4, floating plate 48 remains spaced apart from bracket 42. Thus, in one form, the assembly is designed such that floating plate 48 will not seat against or contact base assembly 40 when door 10 is in the fully open position. Preferably, base assembly 40 is mounted at a position allowing contact between floating plates 35 and 48 just prior to or when leading edge 12 contacts stop 50. Accordingly, if door 10 is further transitioned to the open position after contact between floating plates 35 and 38, piston 44 moves in the direction of arrow 45B thereby reducing the distance between the floating plate 48 and bracket 42 and increasing the distance between retainer ring 46 and bracket 42 until leading edge 12 contacts stop 50.

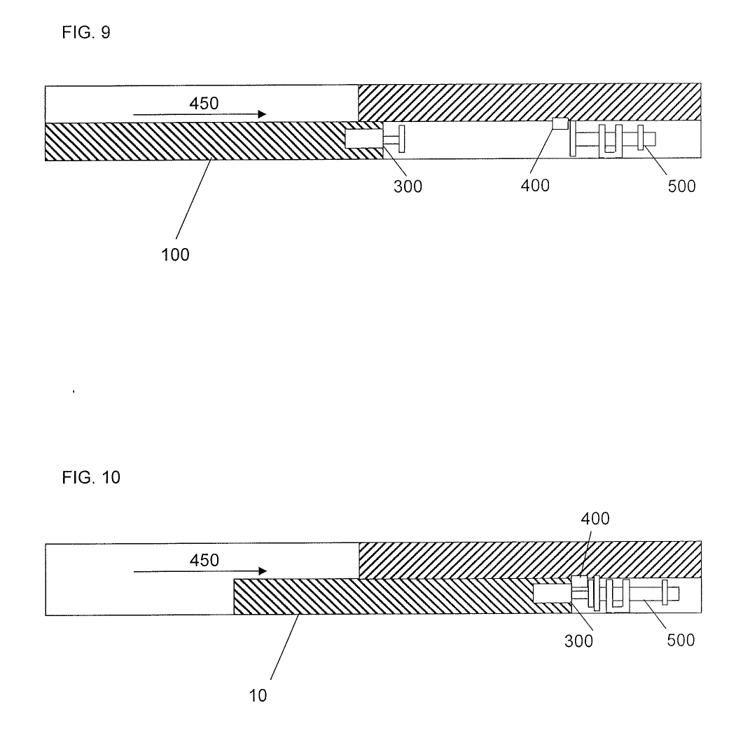

An alternative configuration is depicted in FIGS. 9 and 10 in which floating plate 300 is positioned generally at an end of the leading edge of a door panel 100. Operationally, this door panel and assembly functions similarly to that previously described. Thus, when door panel 100 is slideably moved from a closed position in FIG. 9 to an open position in FIG. 10, floating plate 300 will contact hold open unit 500 and the leading edge of door panel 100 will simultaneously or shortly thereafter contact stop 400. Said contacts will prevent further movement of door panel 100 in the direction of the arrow 450 in FIG. 10 and damaging contact to hold open assembly 8.

The slideable movement of piston 44 and the pivotable mounting of floating plates 35 and 48 allow for a flexible, non-rigid and slideable engagement between floating plates 35 and 48. This minimizes potential damage to hold open assembly 40 offers a mechanism with less rigidity and more yield as compared with prior assemblies. Moreover, as depicted herein, hold open assembly is not the only stop mechanism when the door moves from a closed to an open position. Stop 50 is appropriately positioned to contact leading edge 12 of the door and to minimize contact between the magnetic element and the bracket of the hold open unit, thus, preventing undue damage to the magnetic element as well as to the hold open unit and floating plate.

Although representative processes and articles have been described in detail herein, those skilled in the art will recognize that various substitutions and modifications may be made without departing from the scope and spirit of the invention as described and defined by the appended claims.

What is claimed is:

1. An assembly for holding a door panel in an open position, the assembly comprising:
a first unit having a base and a slideable component, one end of the slideable component supporting a pivotable element; and
a second unit having a base and a pivotable element, the base fixed to and movable with the door panel, the pivotable element operable to contact the pivotable element on the first unit;
wherein the first unit and second unit are positioned along a common trajectory for coupling when the door is in an open position.

2. The system of claim 1 further comprising a stop positioned along the trajectory to contact the end of the door to eliminate direct contact between the first unit base and the first unit pivotable element.

3. The system of claim 1, further comprising a door stop positioned to stop movement of the door after engagement of the first and second pivotable elements.

4. The system of claim 1, wherein the pivoting elements are magnetically attracted to each other.

5. The system of claim 1, wherein the first unit base comprises at least one opening to slideably receive a cylindrical piston movable therein, the pivotable unit disposed on the end of the cylindrical piston.

6. The system of claim 1, wherein the first unit pivotable element is a ceramic disc magnet.

7. The system of claim 1, wherein the second unit base comprises a slot to enable positional adjustment of the pivotable element relative to the second unit base.

8. The system of claim 1, wherein slideable unit is mounted in an opening on the first unit base and comprises a cylindrical cross section.

9. A system for holding a door panel, the system comprising:
a first unit having a base and a slideable component moveable relative to the first unit, the slideable component comprising a coupling element disposed on the end of the slideable component;
a second unit having a base and a coupling element secured thereto, the base fixed to and movable with the door panel, the coupling element securable to the coupling element of the first unit; and
a stop member for contacting the door panel when the first unit and second unit coupling elements are secured together such that the stop member prevents contact between the first unit base and the first unit coupling element.

10. The system of claim 9, wherein the coupling elements are pivotable to facilitate flush engagement therebetween.

11. The system of claim 9, wherein the base of the first unit further comprises a bracket for supporting the slideable component for slideable movement.

12. The system of claim 9, wherein the second unit coupling element is magnetic.

13. The system of claim 9, wherein the first and second coupling elements are magnetically attracted to each other.

14. The system of claim 9, wherein the second unit base comprises an adjustment slot to enable positional adjustment of the coupling element relative to the second unit base.

15. The system of claim 9, wherein the first unit coupling element comprises a ceramic disc magnet.

16. A method for holding a door panel, the method comprising:
providing a door panel slideable along a common path;
positioning a first unit along the common path, the first unit comprising a base portion and slideable component, the slideable component further configured with a coupling element at one end;
fixing a second unit to the door panel for movement along the common path, the second unit further comprising a coupling element for engagement with the first unit coupling element; and
positioning a stop member for contacting the door panel when the first unit and the second unit are coupled, wherein the position of the stop member prevents contact between the first unit coupling element and first unit base.

17. The method of claim 16, wherein the first unit is further configured with a bracket portion for supporting the slideable component.

18. The method of claim 16, wherein coupling elements including providing coupling elements that are magnetically attracted to each other.

19. The method of claim 16, further comprising providing pivotable coupling elements to facilitate flush engagement therebetween.

20. The method of claim 16, further comprising providing an adjustment slot on the second unit base to enable positional adjustment of the coupling element relative to the second unit base.
